(19) United States
(12) Patent Application Publication
(10) Pub. No.: US 2019/0065458 A1
(43) Pub. Date: Feb. 28, 2019

(54) DETERMINATION OF LANGUAGES SPOKEN BY A MEMBER OF A SOCIAL NETWORK

(71) Applicant: LinkedIn Corporation, Sunnyvale, CA (US)

(72) Inventors: Greg Brunet, San Carlos, CA (US); Ajay Srivastava, Milpitas, CA (US); Vita Markman, San Francisco, CA (US)

(21) Appl. No.: 15/682,790

(22) Filed: Aug. 22, 2017

(51) Int. Cl. G06F 17/27; G06Q 50/00

(52) U.S. Cl. CPC G06F 17/275; G06Q 50/01

(57) ABSTRACT

Methods, systems, and computer programs are presented for determining languages spoken by a user based on analysis of the information and activities of the user. One method includes an operation for extracting values for features, associated with a user of a social network, related to a language. Each feature is a primary or a secondary feature. For each primary feature, a determination is made whether the value of the feature exceeds a threshold. The method further includes operations for determining that the user speaks the language when at least one primary feature exceeds the respective threshold, and when no primary feature exceeds the respective threshold, analyzing values of the primary and secondary features to determine if the user speaks the language. The determination that the user speaks the language is stored in the user profile, and the user interface of the social network is customized based on the language.

### TECHNICAL FIELD

The subject matter disclosed herein generally relates to methods, systems, and programs for analyzing data of a user to derive additional information about the user.

### BACKGROUND

Knowing the language users speak is important for many service providers. For example, a social network may tailor services based on the language, or languages, spoken by users. A recruiter advertising on the social network may want to target ads to members that speak a certain language. Also, the social network may wish to tailor the user feed to make sure that the content in the user feed is provided in a language that the user speaks; otherwise, the user may feel disappointed by seeing items in an unspoken language.

Sometimes users enter their language in their profile within the social network, but more often than not, users do not enter in their profiles all the languages they speak. For example, in some social networks, only around 20% of users may fill out the language section in the profile.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments, including a social networking server.

FIG. 2 is a screenshot of a user's profile view, according to some example embodiments.

FIG. 3 illustrates a method and the features used to detect the language spoken by a user, according to some example embodiments.

FIG. 4 illustrates the calculation of a language score, according to some example embodiments.

FIG. 5 illustrates the details for a language scoring algorithm, according to some example embodiments.

FIG. 6 illustrates the training and use of a machine-learning program, according to some example embodiments.

FIG. 7 is a flowchart of a method for determining languages spoken by a user based on analysis of the information and activities of the user, according to some example embodiments.

FIG. 8 illustrates a social networking server for implementing example embodiments.

FIG. 9 is a block diagram illustrating an example of a software architecture that may be installed on a machine, according to some example embodiments.

FIG. 10 illustrates a diagrammatic representation of a machine in the form of a computer system within which a set of instructions may be executed for causing the machine to perform any one or more of the methodologies discussed herein, according to an example embodiment.

### DETAILED DESCRIPTION

Example methods, systems, and computer programs are directed to determining languages spoken by a user based on analysis of the information and activities of the user. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In some social networks, user customization relies on the default locale or interface locale for the member to decide the language for the content presented to the user. However, this data may not accurately represent the member's language preference or take into account that the member may speak several languages. Further, the locale information may be inaccurate for some members, and some members may have joined the social network before their native language was supported in the social network (e.g., a German user joining the social network before the German version was available). This may lead to suboptimal experiences for the users within the social network.

Embodiments presented herein analyze multiple language features to determine the languages spoken by users and their proficiency. The features include, at least, one or more of country code where the user registered, language identified in the profile, skills identified related to language, geography of the school attended by the user, geography of the company the user works for, email domain of the user, etc.

Some features are primary features, which are features that may determine proficiency in a particular language if a condition associated with the feature is met. For example, if a user attended a university, it would be inferred that the user speaks the language spoken in the country where the university is located. In another example, if the user has more than 40% of connections from a particular country, the user will be assumed to speak the language in that particular country.

Some features are secondary features, which are those features that may not by themselves determine if a language is spoken but may contribute to determining if the user speaks the language when combined with other primary or secondary features. The language-scoring algorithm may aggregate the information from multiple features, including primary and secondary features, to determine if the user speaks a certain language with a given probability. The language-scoring algorithm provides a confidence score indicating a probability that the member knows the language (with at least a professional-level proficiency).

Better understanding of the languages spoken by users may assist in providing enhanced services, such as improved filtering of feed items (e.g., to avoid presenting items in a language not spoken by the user), assisting recruiters to find job candidates that speak a certain language, identifying jobs that the user may be interested in based on their language skills, targeting ads for users that speak a certain language, mapping talent for recruiters (e.g., understanding the candidate pool for specific language), offering education courses in a certain language, etc.

Further, better understanding of language also to helps improve the social interactions among members by facilitating interactions by members that can understand each other. Better understanding of language helps eliminate communication barriers in the social network.

One general aspect includes a method including an operation for extracting, by one or more processors, values for a plurality of features associated with a user of a social network, the plurality of features being related to a language, the plurality of features including profile features, and each feature of the plurality of features being a primary feature or a secondary feature. The method also includes determining, for each primary feature, if a value of the feature exceeds a respective predetermined feature threshold, and determining, by the one or more processors, that the user speaks the language when at least one primary feature exceeds the respective predetermined feature threshold. The method further includes, when none of the primary features exceeds the respective predetermined feature threshold, analyzing, by the one or more processors, values of the primary features and the secondary features to determine if the user speaks the language. The one or more processors store the determination that the user speaks the language in a profile of the user, where a user interface of the social network is customized based on the language.

One general aspect includes a system including a memory with instructions and one or more computer processors. The instructions, when executed by the one or more computer processors, cause the one or more computer processors to perform operations including: extracting values for a plurality of features associated with a user of a social network, the plurality of features being related to a language, the plurality of features including profile features, each feature of the plurality of features being a primary feature or a secondary feature; for each primary feature, determining if a value of the feature exceeds a respective predetermined feature threshold; determining that the user speaks the language when at least one primary feature exceeds the respective predetermined feature threshold; when none of the primary features exceed the respective predetermined feature threshold, analyzing values of the primary features and the secondary features to determine if the user speaks the language; and includes storing the determination that the user speaks the language in a profile of the user, where a user interface of the social network is customized based on the language.

One general aspect includes a non-transitory machine-readable storage medium including instructions that, when executed by a machine, cause the machine to perform operations including: extracting values for a plurality of features associated with a user of a social network, the plurality of features being related to a language, the plurality of features including profile features, each feature of the plurality of features being a primary feature or a secondary feature; for each primary feature, determining if a value of the feature exceeds a respective predetermined feature threshold; determining that the user speaks the language when at least one primary feature exceeds the respective predetermined feature threshold; when none of the primary features exceeds the respective predetermined feature threshold, analyzing values of the primary features and the secondary features to determine if the user speaks the language; and includes storing the determination that the user speaks the language in a profile of the user, where a user interface of the social network is customized based on the language.

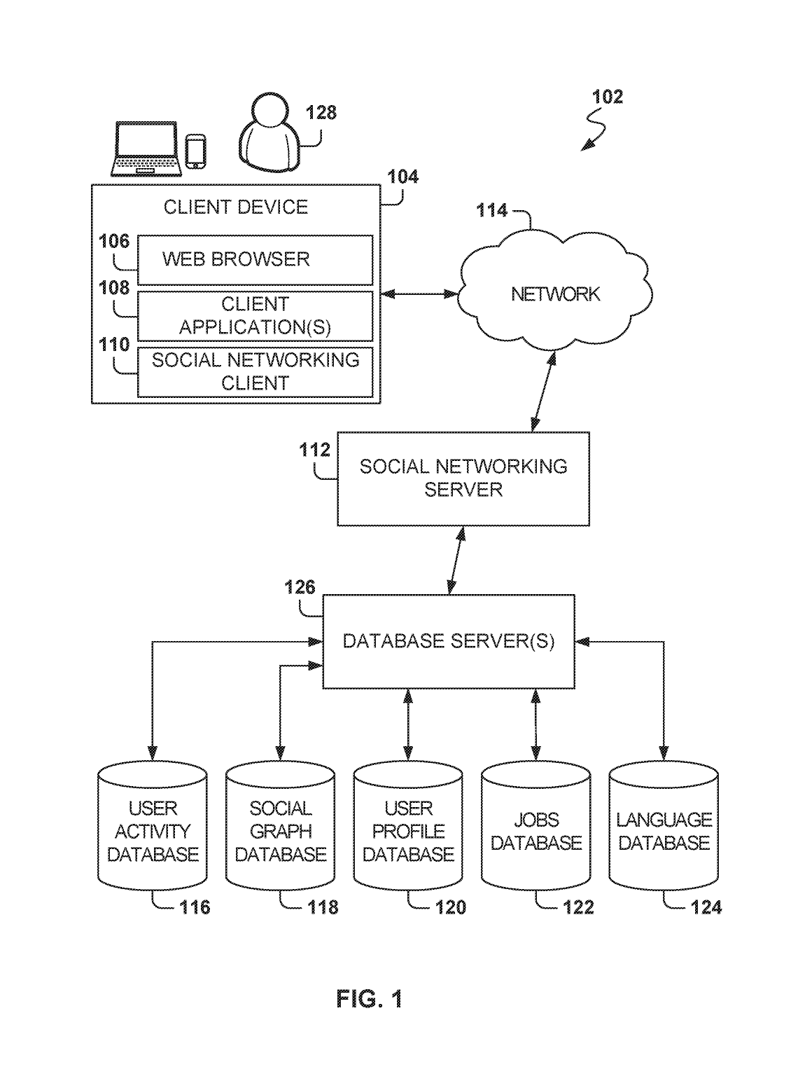

FIG. 1 is a block diagram illustrating a networked system, according to some example embodiments, including a social networking server. The social networking server 112 provides server-side functionality via a network 114 (e.g., the Internet) to one or more client devices 104. FIG. 1 illustrates, for example, a web browser 106, client application(s) 108, and a social networking client 110 executing on a client device 104. The social networking server 112 is further communicatively coupled with one or more database servers 126 that provide access to one or more databases 116-124.

The client device 104 may comprise, but is not limited to, a mobile phone, a desktop computer, a laptop, a tablet, a multi-processor system, a microprocessor-based or programmable consumer electronic system, or any other communication device that a user 128 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth.

In one embodiment, the social networking server 112 is a network-based appliance that responds to initialization requests or search queries from the client device 104. One or more users 128 may be a person, a machine, or other means of interacting with the client device 104.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access a user profile, to authenticate a user 128, to identify or locate other connected users, etc.). Conversely, if the social networking client 110 is not included in the client device 104, the client device 104 may use the web browser 106 to access the social networking server 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database server(s) 126 and database(s) 116-124. In one example embodiment, the social networking server 112 is communicatively coupled to a user activity database 116, a social graph database 118, a user profile database 120, a jobs database 122, and a language database 124. The databases 116-124 may be implemented as one or more types of databases including, but not limited to, a hierarchical database, a relational database, an object-oriented database, one or more flat files, or combinations thereof.

The user profile database 120 stores user profile information about users who have registered with the social networking server 112. With regard to the user profile database 120, the term “user” may include an individual person or an organization, such as a company, a corporation, a nonprofit organization, an educational institution, or other such organizations.

Consistent with some example embodiments, when a user initially registers to become a member of the social networking service provided by the social networking server 112, the user is prompted to provide some personal information, such as name, age (e.g., birth date), gender, interests, contact information, language, home town, address, spouse's and/or family members' names, educational background (e.g., schools, majors, matriculation and/or graduation dates, etc.), employment history, professional industry (also referred to herein simply as industry), skills, professional organizations, and so on. This information is stored, for example, in the user profile database 120. Similarly, when a representative of an organization initially registers the organization with the social networking service provided by the social networking server 112, the representative may be prompted to provide certain information about the organization, such as the company industry. This information may be stored, for example, in the user profile database 120. In some embodiments, the profile data may be processed (e.g., in the background or offline) to generate various derived profile data. For example, if a user has provided information about various job titles that the user has held with the same company or different companies, and for how long, this information may be used to infer or derive a user profile attribute indicating the user's overall seniority level, or seniority level within a particular company. In some example embodiments, importing or otherwise accessing data from one or more externally hosted data sources may enhance profile data for both users and organizations. For instance, with companies in particular, financial data may be imported from one or more external data sources, and made part of a company's profile.

In some example embodiments, a language database 124 stores information regarding languages spoken by users, which may be part of the user's profile.

As users interact with the social networking service provided by the social networking server 112, the social networking server 112 is configured to monitor these interactions. Examples of interactions include, but are not limited to, commenting on posts entered by other users, viewing user profiles, editing or viewing a user's own profile, sharing content outside of the social networking service (e.g., an article provided by an entity other than the social networking server 112), updating a current status, posting content for other users to view and comment on, job suggestions for the users, job-post searches, and other such interactions. In one embodiment, records of these interactions are stored in the user activity database 116, which associates interactions made by a user with his or her user profile stored in the user profile database 120. In one example embodiment, the user activity database 116 includes the posts created by the users of the social networking service for presentation on user feeds.

The jobs database 122 includes job postings offered by companies. Each job posting includes job-related information such as any combination of employer, job title, job description, requirements for the job, salary and benefits, geographic location, one or more job skills required, the day the job was posted, relocation benefits, and the like.

In one embodiment, the social networking server 112 communicates with the various databases 116-124 through the one or more database server(s) 126. In this regard, the database server(s) 126 provide one or more interfaces and/or services for providing content to, modifying content in, removing content from, or otherwise interacting with the databases 116-124.

While the database server(s) 126 is illustrated as a single block, one of ordinary skill in the art will recognize that the database server(s) 126 may include one or more such servers. For example, the database server(s) 126 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-124, or combinations thereof. Accordingly, and in one embodiment, the database server(s) 126 implemented by the social networking service are further configured to communicate with the social networking server 112.

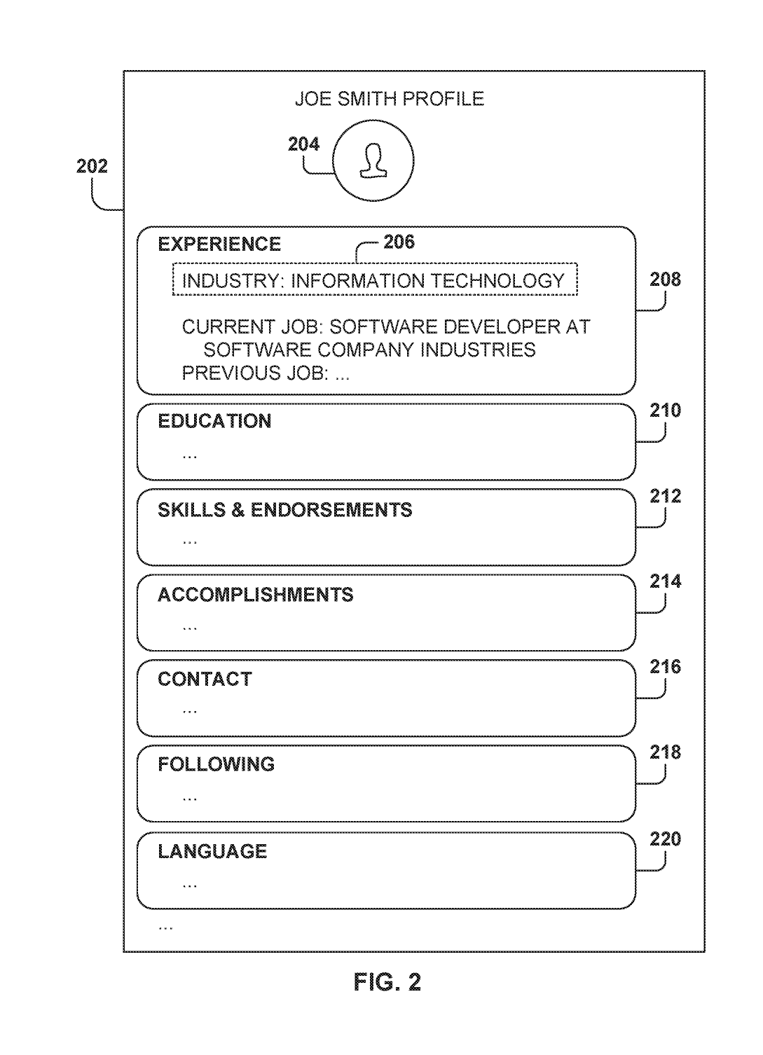

FIG. 2 is a screenshot of a user's profile view, according to some example embodiments. Each user in the social network has a user profile 202, which includes information about the user (e.g., the user 128). The user profile 202 is configurable by the user (e.g., the user 128) and also includes information based on the user activity in the social network (e.g., likes, posts read).

In one example embodiment, the user profile 202 may include information in several categories, such as experience 208, education 210, skills and endorsements 212, accomplishments 214, contact information 216, following 218, language 220, and the like. Skills include professional competencies that the user has, and the skills may be added by the user or by other users of the social network. Example skills include C++. Java, Object Programming, Data Mining, Machine Learning, Data Scientist, Spanish, and the like. Other users of the social network may endorse one or more of the skills and, in some example embodiments, the account is associated with the number of endorsements received for each skill from other users.

The experience 208 category of information includes information related to the professional experience of the user. In one example embodiment, the experience 208 information includes an industry 206, which identifies the industry in which the user works. Some examples of industries configurable in the user profile 202 include information technology, mechanical engineering, marketing, and the like. The user profile 202 is identified as associated with a particular industry 206, and the posts related to that particular industry 206 are considered for inclusion in the user's feed, even if the posts do not originate from the user's connections or from other types of entities that the user explicitly follows. The experience 208 information area may also include information about the current job and previous jobs held by the user.

The education 210 category includes information about the educational background of the user, including educational institutions attended by the user. The skills and endorsements 212 category includes information about professional skills that the user has identified as having been acquired by the user, and endorsements entered by other users of the social network supporting the skills of the user. The accomplishments 214 area includes accomplishments entered by the user, and the contact information 216 includes contact information for the user, such as email and phone number. The following 218 area includes the name of entities in the social network being followed by the user. The language 220 area includes the languages spoken by the user.

The goal of the language-scoring algorithm is to identify the languages spoken by a user and the proficiency in each of the languages. The language-scoring algorithm produces a language score indicating the confidence in attributing the language to the member.

Working proficiency means a person can use the language in some work-related capacity. The proficiency level may be indicated by the user (e.g., understands written language, speaks fluently, native speaker, used at a professional level, etc.), or may be inferred by the language-scoring algorithm based on the association with the user to the particular language. In some example embodiments, the inferences made by the scoring algorithm may be presented to the user and enable the user to change their proficiency level.

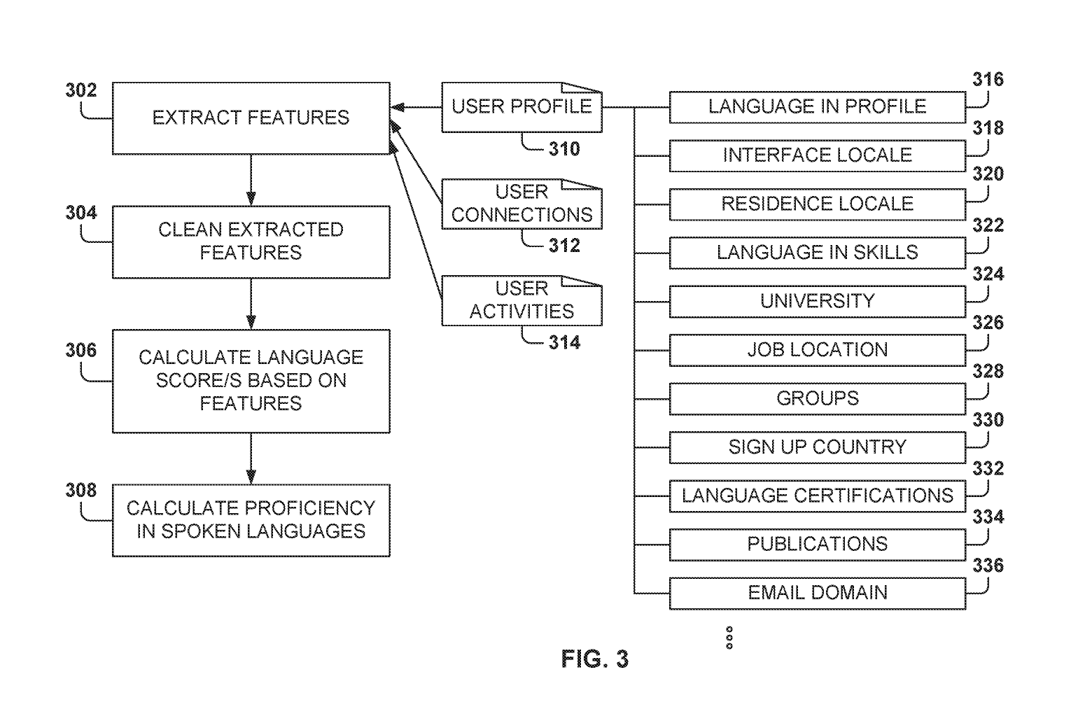

FIG. 3 illustrates a method and the features used to detect the language spoken by a user, according to some example embodiments. At operation 302, the language features are extracted based on information of the user. The information includes user profile 310 data, information about user connections 312, and user activities 314.

From operation 302, the method flows to operation 304, where the extracted features may be cleaned. For example, if the user has entered a typo on the language skills, the typo may be corrected, or if the user has entered language information in the native language instead of in English (e.g., “Español” instead of Spanish), then a standard representation is selected for the extracted features.

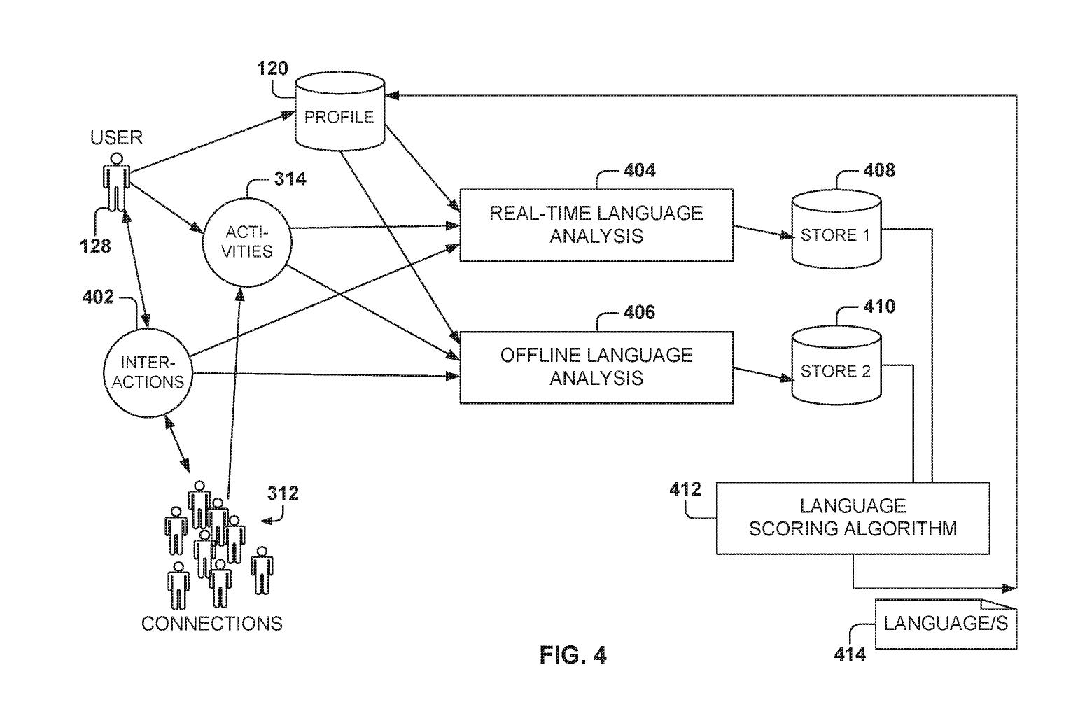

From operation 304, the method flows to operation 306, where the language scores are calculated based on the extracted features. More details are provided below for the language score calculation with reference to FIGS. 4-7.

In some example embodiments, the language score is based on weights assigned to the features. Some features are more important than others, so they are assigned different weights. A high language score reflects a probability that would be similar to what a person may infer regarding the language abilities of the user based on the features. For example, if a user went to university in Germany for four years, it stands to reason that the user speaks German.

In some example embodiments, the weights may be calculated based on one or more buckets created for the respective feature. This way, a plurality of buckets are created for a particular feature, and a related feature is created that includes the bucket corresponding to the particular feature. The weight is then assigned to the related feature based on the buckets. For example, the number of connections in a country may be divided into 10 buckets according to the percentage of connections in that country (e.g., 0-10%, 10%-20%, etc.). The weights assigned to the buckets may not be linear, as a user with 53% connections in a country will have a much higher weight than a user with 17% connections in the country.

Similarly, university attendance may also be broken into buckets according to the duration of attendance (e.g., 0-1 years, 1-2 years, 2-3 years, more than three years). The amount of time working for a company may also be bucketed according to the time at the deposition (e.g., 0-1 years, 1-2 years, 2-5 years, 5-10 years, more than 10 years).

At operation 308, the proficiency in one or more languages is calculated. In some example embodiments, the proficiency may be a binary value: the user speaks the language or the user doesn't. In other example embodiments, the proficiency may be identified as a score within a range (e.g., from 0 to 100), or a proficiency may be identified within one of the predefined number of values, such as does not speak, basic understanding, reads and writes, fluent, and native-speaker level.

The user profile 310 features may include one or more of language in the profile 316, language in the interface locale 318, language spoken where the user lives or lived (language in residence locale 320), language identified in skills 322, language spoken at universities 324 attended by the user, languages spoken at the job location 326 of the user, languages corresponding to groups 328 of the user, language in the sign-up country 330 of the user, language identified in certifications 332 obtained by the user, language of publications 334 of the user, language associated with the email domain 336 of the email of the user, and any other language-related feature.

The language in profile 316 is the language entered by the user when updating the user profile 310. If the user identifies language in the profile 310, then the system assigns a language score of 100% (or 99% in other embodiments); that is, the system will not question the proficiency in that language configured by the user. If the user mentions the language directly in the user profile 310, it is assumed that the user speaks the language.

In some example embodiments, a secondary language profile is available from the social network. Every user can create a secondary language profile in a second language, which is a translated version of the user profile that is seen by users in another locale in a first language. This way, users may now allow people from other locales to view their profiles in the second language. The second language of the secondary profile may also be used as a language feature for inferring the language known by the user.

The language m the interface locale 318 is the language associated with the interface used by the user. For example, a user accessing the social network in the interface provided in France will have French as the interface locale 318. In some example embodiments, the languages spoken at the geographical location used by the user to access the social network is also considered. For example, if the user accesses the social network from California for a period of time (e.g., a year or more), then it will be inferred that the user speaks English.

The language spoken where the user lives, the residence locale 320, is also considered. If the user moves from one country to another, the social network may detect the move (e.g., change of address in the user profile 310) and assume proficiency in the language spoken at the residence locale 320 based on the length of stay in one place. For example, if the user resides in a country for more than a year (or some other threshold period of time), it would be assumed that the user speaks the local language.

Users sometimes enter a language as a skill 322 within the profile 310; it will be inferred that the user speaks the language identified in the skill 322. For example, if a user lists “Russian” as a skill, then it would be inferred that the user speaks Russian.

If the user has attended a university (or some other educational institution) for at least a predetermined period of time, the language spoken at the university 324 will be considered as spoken by the user. For example, if a user went to school in Buenos Aires for two years, the user probably speaks Spanish. In some example embodiments, a threshold amount of time of attendance is required to assume that the user speaks the language. For example, the threshold may be one year or two years.

Similarly, the languages spoken at the job location 326 of the user is a feature used to infer that the user speaks the language. For example if the user worked for two years in Japan, a high probability is assigned to the user speaking Japanese.

Further, if the user belongs to one or more groups within the social network, the languages associated with the groups 328 of the user will be considered as features indicative that the user speaks the group language. Further, the language spoken in the sign-up country 330—where the user signed up for the social network—may be considered likely to be spoken by the user.

Sometimes the user enters, in the user profile 310, certifications obtained. If a language is identified in the certifications 332 obtained by the user (e.g., certification of English as a second language), then the user probably speaks that language. The certifications may also be associated with classes for training attended by the user. Further, the more certifications obtained by the user associated with the language, the more likely it is that the user speaks that language.

If the user enters publications (e.g., professional articles) in the profile, the language of the publications 334 will be assumed to be spoken by the user, or at least, to increase the probability that the user speaks the language.

The language associated with an email address may also be used as a signal of the language spoken by the user. In particular, the language associated with the email domain 336 of the user is used to infer the user's language skill. For example, if the email of the user has the extension “.de”, then it may be inferred that the user speaks German, because the extension “.de” is for the Federal Republic of Germany.

The user connections 312 may also indicate a spoken language. For example, if 40% or more of the connections of the user (or some other threshold level) are within a certain country (or speak a certain language), then it may be assumed that the user speaks the language of the country. It is likely that the user has so many connections in the country because the user has lived there, worked there, or was born there, so it is likely that the user speaks the language.

If the user has a considerable number of connections within the country (e.g., 20%), but not enough to reach the threshold, then this feature will be considered by the algorithm and combined with other features for determining the spoken language. However, it will not be as determinative as if the user has 40% of connections from the country. That is, a threshold number of connections is defined, such that if the user exceeds the threshold number of connections within a country, then the language will be assigned to the user; otherwise, the number of connections will be used with other features. It is noted that the threshold (e.g., 40% of connections within a country) is a parameter that may be fine-tuned by the system. For example, the threshold may be changed based on feedback provided by users when asked to confirm if they speak the language of the user's connections.

The user activities 314 may also provide features to identify the language of the user. For example, when a user interacts with posts of other users in the user's feed, activities such as “Like,” “Reply,” or “Share” will increase the probability that the user speaks the language of the post that the user interacted with.

In some example embodiments, the history of activities of the user within the social network is analyzed to determine activities associated with a spoken language. Further, the location from which the user is accessing the social network may be considered as an indication (e.g., by analyzing the geolocation of the Internet Protocol address of the user).

It is noted that one of the features not included in the list, of language-related features, is the name or ethnicity of the user. In other solutions, marketing campaigns may be initialized based on the name of the user. For example, if the last name of the user is “Smith,” an assumption is made that the user speaks English, and if the last name of the user is “Lopez,” then an assumption is made that the user speaks Spanish. But this approach may result in many false conclusions. For example, a user with the last name “Lopez” may be a third or fourth generation American native, with English as their first language, and may not even speak Spanish. Further, a user may have a last name adopted from a spouse after marriage, and the last name may have nothing to do with the background of the user. In addition, this kind of assumption may create negative feelings for users because they may feel mischaracterized or stereotyped.

In some example embodiments, once a language is identified as possibly being spoken by the user, but not currently part of the user's profile, the user is presented with a question to confirm proficiency in that language. The user may then confirm or deny language proficiency. Further, the feedback of the user may be used to fine-tune the parameters used by the language-scoring algorithm based on the assumptions made and the user's responses.

FIG. 4 illustrates the calculation of the language score, according to some example embodiments. The user 128 has interactions 402 with other users of the social network (e.g., user connections 312) as well as with other people outside the social network (not shown). In addition, the activities (within the social network and outside the social network, in some example embodiments) of the user activities 314 are monitored to identify features that may identify the languages spoken by the user 128.

In some example embodiments, identifying the language includes two phases: a real-time language analysis 404 and an offline language analysis 406. As the name indicates, the real-time language analysis 404 is performed in real time on an ongoing basis by checking the user profile database 120, activities 314, and interactions 402. For example, by detecting that the user is interacting with one or more connections 312 speaking Chinese, the real-time language analysis 404 may identify that the user speaks Chinese.

The offline language analysis 406 is performed periodically (e.g., once a day) to analyze static information about the user that doesn't change often, such as information in the user profile database 120 regarding the address of the user, the job of the user, the email of the user, etc. In some example embodiments, offline language analysis 406 includes tracking how the user is interacting with content, not only how the content is shared or commented, but also how much time the user spends on content (e.g., gaze time on the content), and determining the language of the content.

The results of the real-time language analysis 404 are stored in a first database, Store 1 408, and the results of the off-line language analysis 406 are stored in a second database, Store 2 410. The data stored in the databases 408 and 410 includes the languages spoken by the user and the associated language score. In addition, some of the language-related features may also be kept in databases 408 and 410, such as the number of connections 312 of the user that speak a particular language, interactions 402 of the user in a particular language, etc.

It is noted that separating the analysis into real-time and offline allows the system to process a large amount of data for identifying the language, while still providing dynamic analysis to quickly identify languages spoken by the user. The social network may have half a billion users, so analyzing all the features for this large amount of users could overwhelm the computing resources of the social network. However, by performing offline analysis on static data, the system is able to focus on dynamic data on an ongoing basis, greatly reducing the amount of features to be analyzed in real time to generate language inferences.

The language scoring algorithm 412 utilizes the data from the real-time and off-line language analyses 404, 406 and identifies the language or languages 414 spoken by the user and the corresponding language scores (e.g., the probability that the user speaks the language). The identified languages 414 are then stored in the user profile database 120.

Knowing the language spoken by users has multiple beneficial use cases, which include, at least, feed filtering, recruiting, identifying jobs for users, targeted ads, education courses, channels on the social network, identifying possible contacts, improved search, offering language suggestions, etc.

Knowing the language spoken by the user helps with filtering feed items by eliminating items in a language not spoken by the user. If the user sees many items in a language the user doesn't understand, the user may be discouraged with the social network and decrease engagement. For example, if the user has Portuguese friends but the user does not speak Portuguese, the feed may start showing items in Portuguese that the user is not able to understand. This may be a big problem in teams with a lot of members from different counties (e.g., development teams with engineers of multiple nationalities).

Further, some language-specific content may be boosted in the feed, such as sponsored ads, shares, likes, etc. This will improve the feed inventory available to show the user as well as improve user satisfaction and engagement.

Recruiters are able to search more effectively for candidates, especially in cases where a language skill is required, e.g., “show me engineers that speak Japanese.” Further, recruiters may be able to identify a better pool of candidates for a relocation opportunity; it will be easier to find an engineer to work in Japan if the engineer speaks Japanese. Additionally, recruiters are able to better understand the pool of available candidates that speak a certain language, and better understand the size of the pool will assist the recruiter in identifying incentives and salaries to attract candidates. It is noted that in some cases, it has been observed that about 2% of searches for candidates involve language skills.

In some example embodiments, the social network identifies jobs that match the professional profile of the user, without having the user expressly initiate the search. By understanding the languages spoken by the user, the search for possible jobs will improve by uncovering opportunities that are language related. For example, if the job requires the candidate to speak Italian, identifying that the user speaks Italian will open this type of job opportunity to the user.

Knowing the user's language may also help in placing targeted ads in a particular language. For example, a marketing campaign may be set up to target German speakers residing in the United States. Further, knowing the language of the user will avoid showing advertisements in language that the user does not comprehend.

Education course offerings may also be tailored to the languages spoken by the user, by showing education possibilities to the user in the language or languages spoken by the user. For example, technical courses in English may be offered to Chinese engineers who speak English.

In some example embodiments, the social network offers information channels to the members of the social network. By understanding the languages spoken by the user, the social network may recommend channels to the user, such as recommending Portuguese channels to Portuguese speakers outside Brazil.

Knowledge of the user's language may also be utilized to improve suggestions for possible new contacts in the social network by tailoring the suggestions to the languages spoken by the user. For example, a suggestion to an American user of a Chinese contact may include translating the name of the Chinese contact to English, if the American user does not speak Chinese.

Further, in some example embodiments, one or more translate buttons may be offered in the user feed interface (e.g., comment and shares) when content is detected in a language not spoken by the user. The one or more buttons may include options to translate the content to the one or more languages spoken by the user, where the languages may include the languages configured especially by the user or the languages inferred by the system.

In some example embodiments, features are providers so social network uses may interact with each other, even when they don't speak the same language (e.g., comments, messages exchange within the social network, etc.). For example, if a user sends a message within the social network to another user that does not speak the same language, the social network may automatically translate the message to a language spoken by the recipient, such as by translating a message in Japanese to English for an American recipient that does not speak Japanese.

Searches may also be improved by knowing the languages of the user, because the search results may be filtered to show only the search results in the languages spoken by the user. This is more flexible than simply identifying the language of the query, because the search results may also include results in languages other than the language of the search query, as long as the user speaks that language.

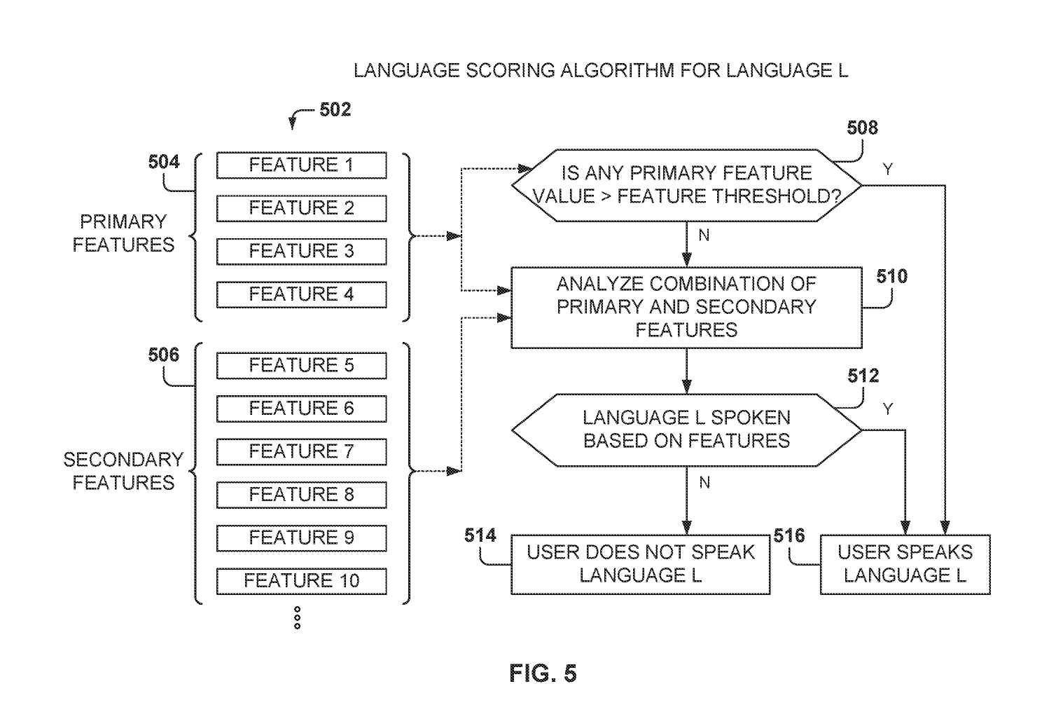

FIG. 5 illustrates the details for the language scoring algorithm, according to some example embodiments. The features 502 for identifying language, also referred to herein as signals, are divided into primary features 504 and secondary features 506. A primary feature 504 is a feature that may provide enough information to infer that the user speaks a language, without requiring additional data. A secondary feature 506 is a feature that may not by itself provide enough information to infer the spoken language, but that may contribute to the determination that the user speaks the language.

Primary features 504 are associated with a value and a threshold, such that if the value of the feature is greater than or equal to the threshold, then a determination is made that the user speaks the language. For example, a feature that identifies the language spoken in a location where the user works may be associated with a one-year threshold. For example, if the user worked at a job for more than one year, it will be assumed that the user speaks the language spoken in the job location.

In some example embodiments, and referring to FIG. 3, primary features 504 include language in skills 322, language spoken at a job location 326, language spoken at a university 324 attended by the user, language associated with an email domain 336, and percentage of user connections 312 speaking a language. In other embodiments, other primary features may also be utilized.

The threshold for the language skill is simply that the user identifies the language as a skill in the user profile 310. The threshold for the language spoken at a university 324 may be one-year attendance or two-your attendance, depending on the embodiments, and other periods may also be utilized. The threshold for the language associated with an email domain 336 is simply the existence of the email domain. The threshold for the percentage of user connections 312 may be 40%, in some example embodiments, but other values may also be utilized (e.g., in the range of 25%-75%). It is noted that the threshold may be fine-tuned by the system based on evaluation of the results and feedback from users.

In some example embodiments, secondary features 506 may include social network groups, language certifications, publications, and other features. When a primary feature 504 doesn't meet the threshold, then the primary feature 504 may be also used with the secondary features 506 to aggregate information from the features 502 in order to determine if the user speaks the language.

At operation 508, a check is made to determine if any of the primary features 504 exceeds their respective threshold for the language L being scored. If any of the primary features 504 exceeds the threshold, the method flows to operation 516, where a determination is made that the user speaks the language L; otherwise, the method flows to operation 510.

At operation 510, the primary features 504 and the secondary features 506 are analyzed together to make an assessment regarding language L. In some example embodiments, a weighted sum is used to generate the language score, as shown in the following equation:

LS=min(Σᵢwᵢ·fᵢ,0.99) (1)

In equation (1), LS is the language score, i is the index for the features, and wᵢ is the weight for feature fᵢ. The minimum function is used to max out the value of the LS score to 0.99. In other embodiments, other functions may be utilized to aggregate the feature values, such as a calculating the geometric mean.

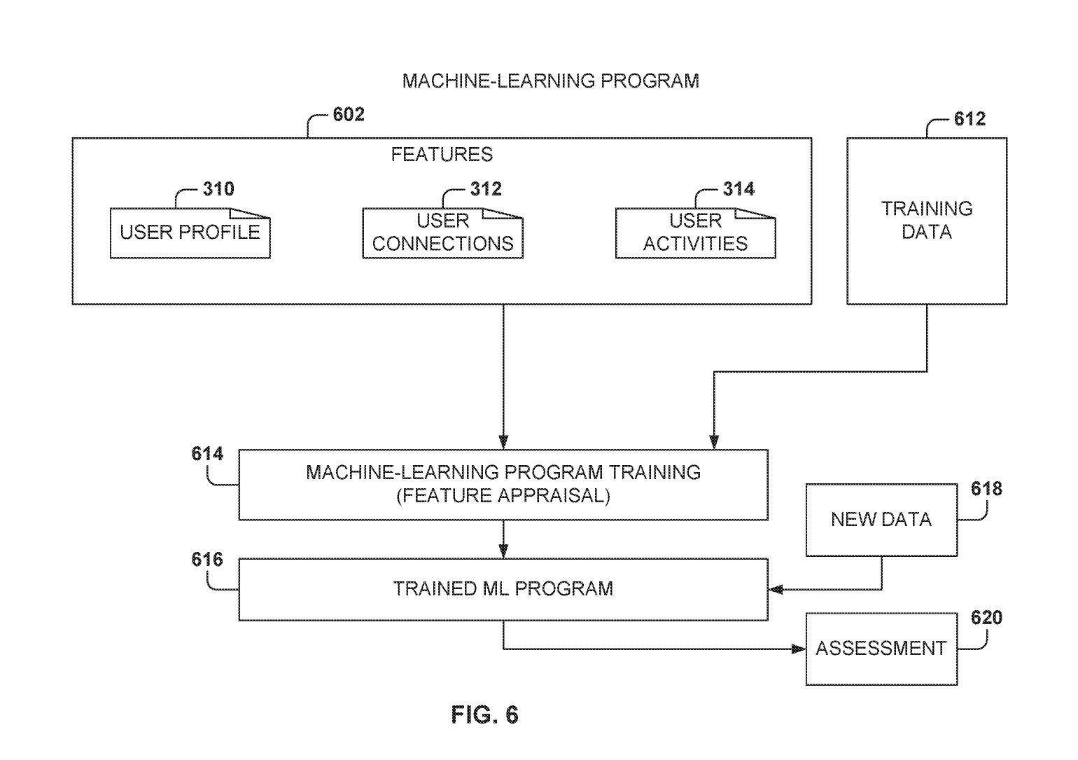

In other example embodiments, the language score may be calculated utilizing a machine-learning program. More details are provided below with reference to FIG. 6 for calculating the score with the machine-learning program.

In some example embodiments, the weights for particular features may be calculated based on analysis of current data. For example, to determine the percentage of people who speak a language, but have less than a predetermined number of connections in the country speaking the language, a method is used to determine how many people speak the language but are below the threshold percentage of connections. For example, to calculate the number of German-speaking people that have less than 40% connections in Germany, the following method may be used:

A. Collect samples of 1000 members who attended school in Germany, under the assumption that every member in the sample speaks German as they attended a university in Germany.

B. Count the number of members with less than 40% connections in Germany (e.g., 100).

C. Compute a fraction of the count from step B (100) out of the total members in sample (1000) (e.g., 100/1000=0.1)

D. Repeat steps A-C for several other languages (e.g., 5 or 6).

E. Average the scores across the plurality of languages to identify an average fraction of people speaking a language and having less than the threshold percentage of connections.

In other example embodiments, instead of utilizing a percentage threshold, both the threshold and the weight are calculated via decision trees or via logistic regression.

The identified fraction is used to fine tune the algorithm, so the algorithm will calculate the fraction of users who speak the language yet have fewer connections than the threshold percentage. In other words, the fraction may be used to adjust the weight for the feature.

At operation 512, a check is made to determine if the language L is spoken by the user based on the analysis performed at operation 510. If the language L is determined to be spoken by the user, the method flows to operation 516; otherwise, the method flows to operation 514, where a determination is made that the user does not speak the language L (e.g., the language score is zero).

At operation 516, a determination is made that the user speaks the language L. and a language score is identified. For example, a language a score of 0.99 is assigned when it is inferred that the user speaks the language, but other language scores are also possible.

To evaluate the performance of the language-scoring algorithm, a test was made to compare evaluations from the language-scoring algorithm and human judges. The test was performed on data not previously processed by the algorithm (e.g., a golden set). The golden set included 1000 examples of member profiles across different regions. Information indicative of languages spoken such as school, connections, email address domain, languages listed in user profile, and interface locale, was extracted for these members. Real member IDs were masked for privacy reasons prior to uploading the data.

Humans were asked to check off from a list of languages any language(s) that a user may know based on the information presented. At least three raters saw each sample. The language algorithm was executed on the sample data to determine the language scores for all the samples. A calculation was made for the completeness/recall indicating how many languages were inferred correctly out of total languages the member knows (e.g., TruePositive/(TruePositive+FalseNegative)). Additionally, precision was calculated to indicate how many languages were identified correctly out of the total languages infer for the member (e.g., TruePositive/(TruePositive+FalsePositive).

For example, if it is inferred that the user knows {EN, ES, DE}, but the user actually knows {EN, DE, ZH}, then the recall is 2/3. If a member knows {EN} (English), and the member actually knows {EN, DE, ZH}, then precision is 1/1, or 100%, but some languages were missed. Hence, both metrics are important.

The results of the test are summarized in Table 1 below:

TABLE 1

| % inferred equally | % inferred differently | % baseline: |
|---|---|---|
| to judges | from judges | languages in profile |
| 869/932 = 93% | Missed member: 1 | Baseline 223/932 |
| (confident matches) | Total error: 62/932 = | Only 223 members |
| | 6.6% | listed a language in |
| | | profile |
| 819/932 = 88% | | Baseline |
| (identical matches) | | inference = 24% |

It is noted that after errors were analyzed, 76 examples marked incorrectly by humans were actually correct after second review. It appears some judges did not know that German is spoken in Switzerland and routinely failed to mark “Hindi” for people who live or have studied in India. After correcting for the human errors and spot-checking results where humans agree with the algorithm, the results from Table 1 were observed.

When analyzing the discrepancies, several reasons were identified, such as attributing French to all the people who live in Canada (this caused about 54% of all errors). Another error was attributing Hindi to people who live in Indonesia (about 7% of all errors). This error appears to be caused because the country code for Indonesia is sometimes written “IN” instead of “ID,” where “IN” is the code for India. Other errors included attributing “Chinese” to Singapore (the national language is Malay, though many people do speak Chinese), and attributing Dutch as the national language of Belgium (only some provinces are Dutch speaking).

Under-inferring errors was due mainly to failing to convert a language name string like “Español” to the corresponding language code, failing to match “Filipino” to “Tagalog.” not finding a language like Sinhala or Cantonese, or not finding spelling variants for a language (e.g., simplified Chinese).

The test results showed that the language-scoring algorithm was able to correctly infer 90% of languages, which was 61% more than the baseline of identifying languages only in the member's profile. Also, the algorithm predicted the same results 93% of the time as human judges. After correcting for errors and by learning over time, the algorithm is expected to be 95% accurate or more, such as 99% accurate.

Another test was performed to identify languages of members within a given profession. For example, 20% more engineers in California were discovered to know French based on inferred-language features (e.g., number of connections, position, and education) though they did not list French on their profile.

FIG. 6 illustrates the training and use of a machine-learning program, according to some example embodiments. In some example embodiments, machine-learning programs (MLPs), also referred to as machine-learning algorithms or tools, are utilized to perform operations associated with identifying languages.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data in order to make data-driven predictions or decisions expressed as outputs or assessments. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring spoken languages.

In general, there are two types of problems in machine learning: classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, example machine-learning algorithms provide a language score (e.g., a number from 1 to 100) to qualify each language as a match for the user. The machine-learning algorithms utilize training data 612 to find correlations among identified features 602 that affect the outcome.

The machine-learning algorithms utilize features for analyzing the data to generate assessments 620. A feature 602 is an individual measurable property of a phenomenon being observed. The concept of feature is related to that of an explanatory variable used in statistical techniques such as linear regression. Choosing informative, discriminating, and independent features is important for effective operation of the MLP in pattern recognition, classification, and regression. Features may be of different types, such as numeric, strings, and graphs.

In one example embodiment, and as illustrated in FIG. 6, the features 602 may be of different types and may include one or more of user profile 310, user connections 312, and user activities 314, as discussed above with reference to FIG. 3.

The machine-learning algorithms utilize the training data 612 to find correlations among the identified features 602 that affect the outcome or assessment 620. In some example embodiments, the training data 612 includes known data for one or more identified features 602 and one or more outcomes, such as languages spoken by users, and their respective user profiles 310, user connections 312, and user activities 314.

With the training data 612 and the identified features 602, the machine-learning tool is trained at operation 614. The machine-learning tool appraises the value of the features 602 as they correlate to the training data 612. The result of the training is the trained machine-learning program 616.

When the machine-learning program 616 is used to perform an assessment, new data 618 is provided as an input to the trained machine-learning program 616, and the machine-learning program 616 generates the assessment 620 as output, such as the language score or scores for the user.

It is noted that as additional data and feedback from users is available, it is possible to re-train the machine-learning program 616 in order to continue improving prediction accuracy.

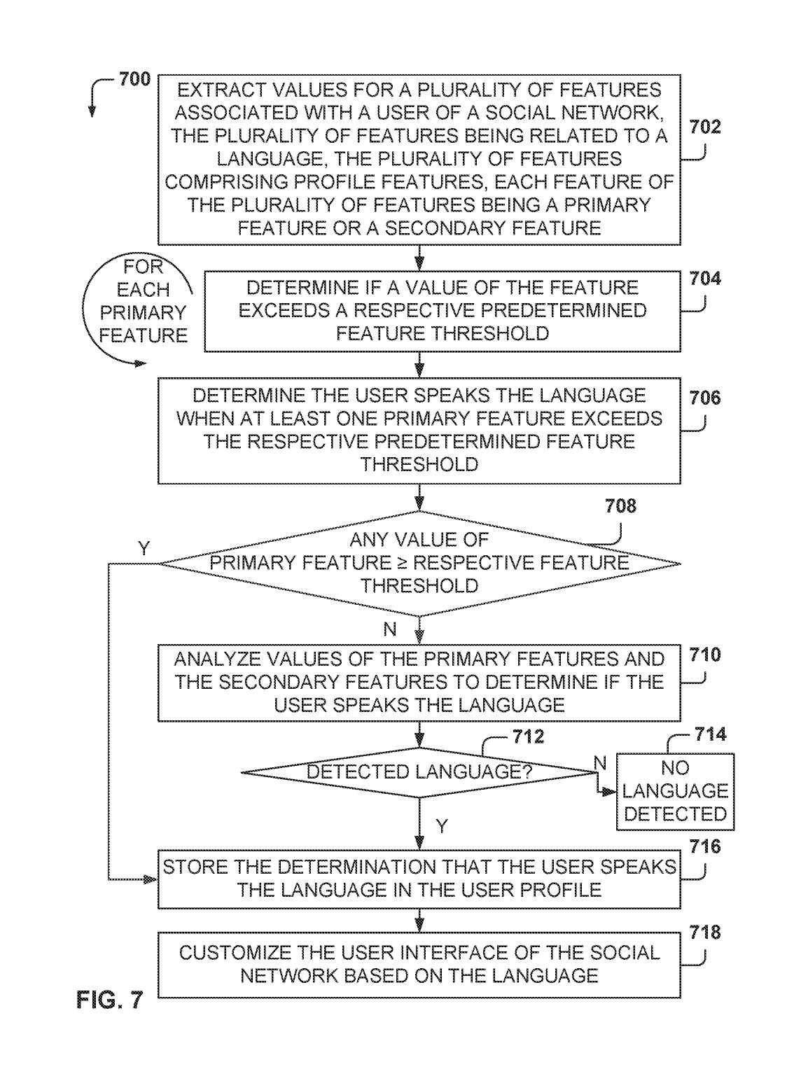

FIG. 7 is a flowchart of a method 700 for determining languages spoken by a user based on analysis of the information and activities of the user, according to some example embodiments. While the various operations in this flowchart are presented and described sequentially, one of ordinary skill will appreciate that some or all of the operations may be executed in a different order, be combined or omitted, or be executed in parallel.

At operation 702, one or more processors extract values for a plurality of features associated with a user of a social network, the plurality of features being related to a language, the plurality of features comprising profile features, and each feature of the plurality of features being a primary feature or a secondary feature.

From operation 702, the method 700 flows to operation 704, where, for each primary feature, the one or more processors determine if a value of the feature exceeds a respective predetermined feature threshold. From operation 704, the method 700 flows to operation 706 to determine, by the one or more processors, that the user speaks the language when at least one primary feature exceeds the respective predetermined feature threshold.

At operation 708, a check is made to determine if any value of any primary feature is greater than or equal to the respective feature threshold. When none of the primary features exceeds the respective predetermined feature threshold, the method 700 flows to operation 710 for analyzing, by the one or more processors, values of the primary features and the secondary features to determine if the user speaks the language. At operation 72, a check is made to determine if a language was detected at operation 710 because some value of the primary features is greater than or equal the respective feature threshold. If a language is detected, the method 700 flows to operation 716; otherwise, the method flows to operation 714, where a determination is made that no new language has been detected.

Operation 716 is for storing, in a profile of the user, by the one or more processors, the determination that the user speaks the language. From operation 716, the method 700) flows to operation 718, where the user interface of the social network is customized based on the language.

In one example, the plurality of features further comprise user-connection features and user-activity features, the user-connection features including data about connections of the user, the user-activity features providing data about activities of the user on the social network.

In one example, primary features are features that may determine proficiency in a particular language if a condition associated with the feature is met, the primary features including language spoken at a job location, language spoken at a university attended by the user, language associated with an email domain, and percentage of the user's connections speaking the language.

In one example, secondary features are features that may not by themselves determine if a language is spoken but may contribute to determining that the user speaks the language when combined with other primary or secondary features, the secondary features including social network groups of the user, language certifications of the user, and publications of the user.

In one example, the profile features include one or more of language in the profile, language in an interface locale, language spoken where the user lives or lived, language identified in skills, language spoken at universities attended by the user, language spoken at a job location of the user, language corresponding to groups of the user, language in a sign-up country of the user, language identified in certifications obtained by the user, language of publications of the user, and language associated with an email domain of an email of the user.

In one example, analyzing values of the primary features and the secondary features further comprises calculating a weighted sum of values of the primary features and the secondary features indicating the language is spoken.

In one example, analyzing values of the primary features and the secondary features further comprises utilizing a machine-learning program to determine if the user speaks the language, the machine-learning program being associated with the plurality of features and being trained with data indicating values of a set of features and an indication if the user speaks the language.

In one example, a plurality of use cases associated with the social network are related to the language determined for the user, the use cases comprising any combination of feed filtering, recruiting, identifying jobs for the user, targeting advertisements, providing education courses, suggesting channels on the social network, identifying possible new contacts for the user, and improving searches.

In one example, the plurality of features includes a number of connections of the user in a country speaking the language, wherein it is determined that the user speaks the language when the number of connections in the country exceeds the respective predetermined feature threshold.

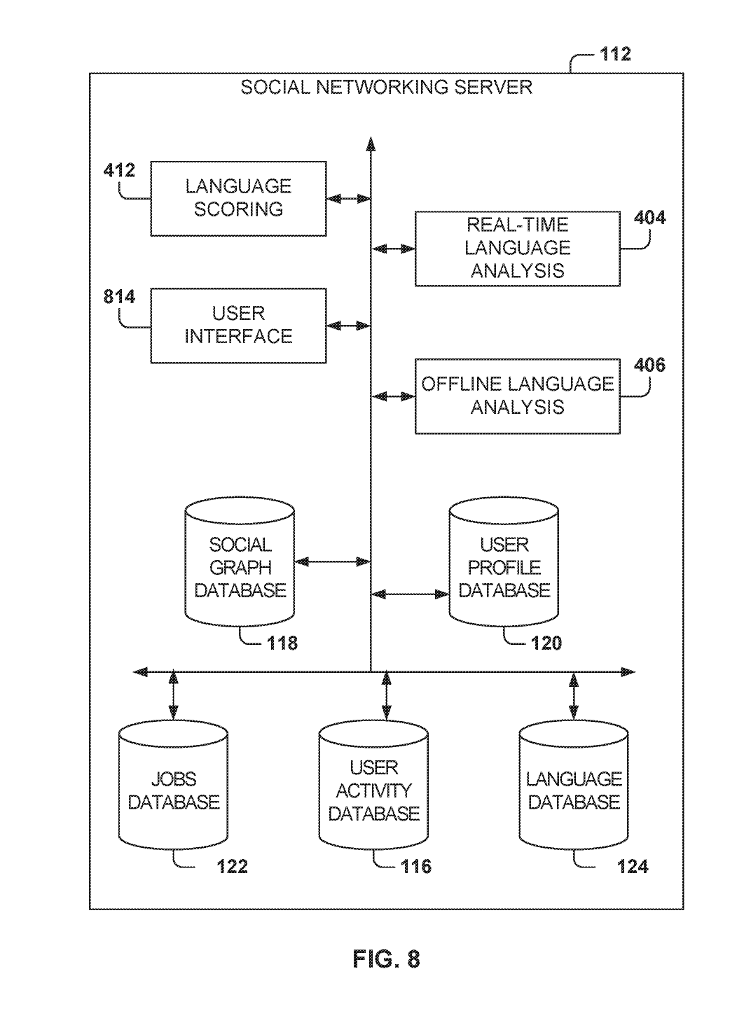

FIG. 8 illustrates a social networking server 112 for implementing example embodiments. In one example embodiment, the social networking server 112 includes a language-scoring algorithm 412 (also referred to herein as language-scoring program), a real-time language analysis 404 program, an off-line language analysis 406 program, a user interface 814, and a plurality of databases, which include the social graph database 118, the user profile database 120, the jobs database 122, the user activity database 116, and the language database 124.

The language-scoring algorithm 412 (or program) calculates language scores for the users in the social network. For example, the language-scoring algorithm 412 performs the operations illustrated with reference to FIGS. 3-7. The real-time language analysis 404 program and the off-line language analysis 406 program perform the operations described above with reference to FIG. 4.

The user interface 814 communicates with the client devices 104 to exchange user interface data for presenting the user interface 814 to the user, e.g., the user 128. It is noted that the embodiments illustrated in FIG. 8 are examples and do not describe every possible embodiment. Other embodiments may utilize different servers, additional servers, combine the functionality of two or more servers into a single server, utilize a distributed server pool, and so forth. The embodiments illustrated in FIG. 8 should therefore not be interpreted to be exclusive or limiting, but rather illustrative.

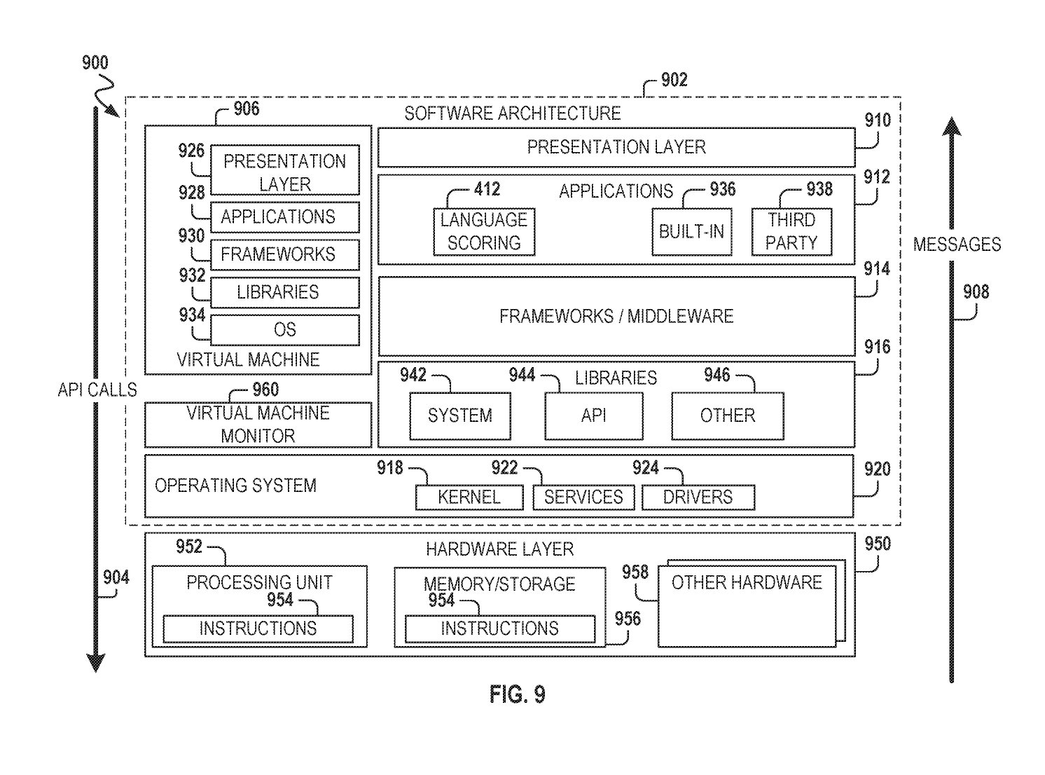

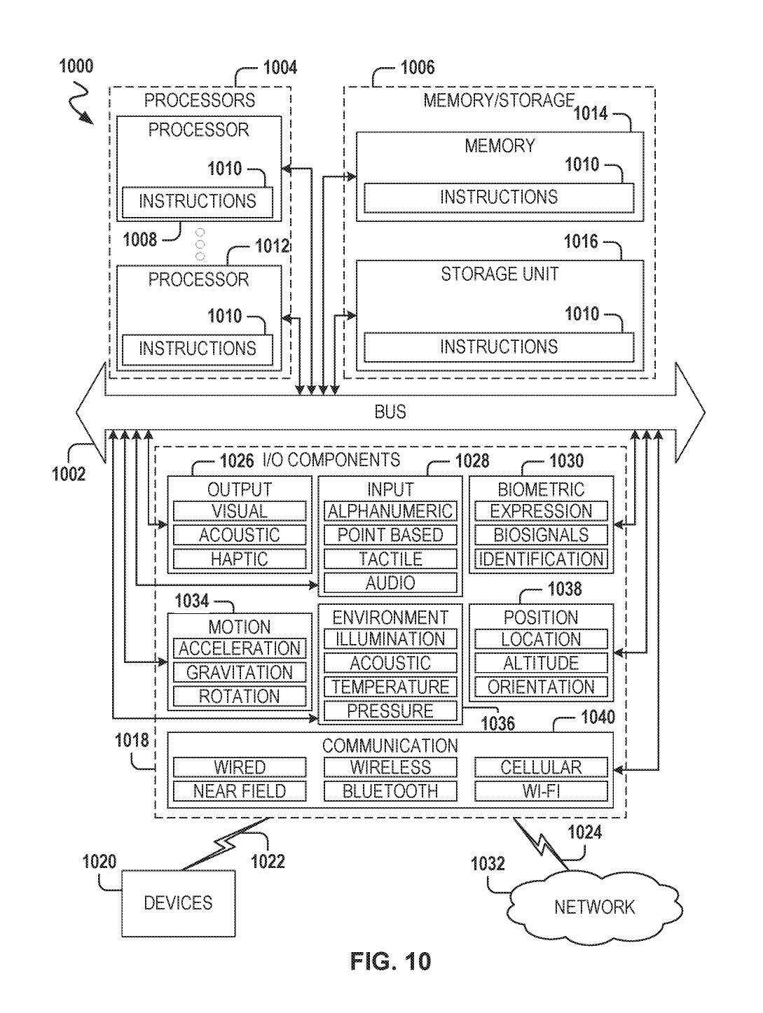

FIG. 9 is a block diagram illustrating an example of a software architecture that may be installed on a machine, according to some example embodiments. FIG. 9 is merely a non-limiting example of a software architecture 902 and it will be appreciated that many other architectures may be implemented to facilitate the functionality described herein. The software architecture 902 may be executing on hardware such as a machine 1000 of FIG. 10 that includes, among other things, processors 1004, memory/storage 1006, and input/output (I/O) components 1018. A representative hardware layer 950 is illustrated and may represent, for example, the machine 1000 of FIG. 10. The representative hardware layer 950 comprises one or more processing units 952 having associated executable instructions 954. The executable instructions 954 represent the executable instructions of the software architecture 902, including implementation of the methods, modules and so forth of FIGS. 1-8. The hardware layer 950 also includes memory and/or storage modules 956, which also have the executable instructions 954. The hardware layer 950 may also comprise other hardware 958, which represents any other hardware of the hardware layer 950, such as the other hardware illustrated as part of the machine 1000.

In the example architecture of FIG. 9, the software architecture 902 may be conceptualized as a stack of layers where each layer provides particular functionality. For example, the software architecture 902 may include layers such as an operating system 920, libraries 916, frameworks/middleware 914, applications 912, and a presentation layer 910. Operationally, the applications 912 and/or other components within the layers may invoke application programming interface (API) calls 904 through the software stack and receive a response, returned values, and so forth illustrated as messages 908 in response to the API calls 904. The layers illustrated are representative in nature and not all software architectures have all layers. For example, some mobile or special purpose operating systems may not provide a frameworks/middleware 914 layer, while others may provide such a layer. Other software architectures may include additional or different layers.

The operating system 920 may manage hardware resources and provide common services. The operating system 920 may include, for example, a kernel 918, services 922, and drivers 924. The kernel 918 may act as an abstraction layer between the hardware and the other software layers. For example, the kernel 918 may be responsible for memory management, processor management (e.g., scheduling), component management, networking, security settings, and so on. The services 922 may provide other common services for the other software layers. The drivers 924 may be responsible for controlling or interfacing with the underlying hardware. For instance, the drivers 924 may include display drivers, camera drivers. Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 916 may provide a common infrastructure that may be utilized by the applications 912 and/or other components and/or layers. The libraries 916 typically provide functionality that allows other software modules to perform tasks in an easier fashion than to interface directly with the underlying operating system 920 functionality (e.g., kernel 918, services 922, and/or drivers 924). The libraries 916 may include system libraries 942 (e.g., C standard library) that may provide functions such as memory allocation functions, string manipulation functions, mathematic functions, and the like. In addition, the libraries 916 may include API libraries 944 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 916 may also include a wide variety of other libraries 946 to provide many other APIs to the applications 912 and other software components/modules.

The frameworks 914 (also sometimes referred to as middleware) may provide a higher-level common infrastructure that may be utilized by the applications 912 and/or other software components/modules. For example, the frameworks 914 may provide various graphic user interface (GUI) functions, high-level resource management, high-level location services, and so forth. The frameworks 914 may provide a broad spectrum of other APIs that may be utilized by the applications 912 and/or other software components/modules, some of which may be specific to a particular operating system or platform.

The applications 912 include the language scoring algorithm 412, built-in applications 936, and third-party applications 938. Examples of representative built-in applications 936 may include, but are not limited to, a contacts application, a browser application, a book reader application, a location application, a media application, a messaging application, and/or a game application. The third-party applications 938 may include any of the built-in applications 936 as well as a broad assortment of other applications. In a specific example, the third-party application 938 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 938 may invoke the API calls 904 provided by the mobile operating system such as the operating system 920 to facilitate functionality described herein.

The applications 912 may utilize built-in operating system functions (e.g., kernel 918, services 922, and/or drivers 924), libraries (e.g., system libraries 942, API libraries 944, and other libraries 946), or frameworks/middleware 914 to create user interfaces to interact with users of the system. Alternatively, or additionally, in some systems, interactions with a user may occur through a presentation layer, such as the presentation layer 910. In these systems, the application/module “logic” may be separated from the aspects of the application/module that interact with a user.

Some software architectures utilize virtual machines. In the example of FIG. 9, this is illustrated by a virtual machine 906. A virtual machine creates a software environment where applications/modules may execute as if they were executing on a hardware machine (such as the machine 1000 of FIG. 10, for example). The virtual machine 906 is hosted by a host operating system (e.g., operating system 920 in FIG. 9) and typically, although not always, has a virtual machine monitor 960, which manages the operation of the virtual machine 906 as well as the interface with the host operating system (e.g., operating system 920). A software architecture executes within the virtual machine 906 such as an operating system 934, libraries 932, frameworks/middleware 930, applications 928, and/or a presentation layer 926. These layers of software architecture executing within the virtual machine 906 may be the same as corresponding layers previously described or may be different.

FIG. 10 illustrates a diagrammatic representation of a machine in the form of a computer system within which a set of instructions may be executed for causing the machine to perform any one or more of the methodologies discussed herein, according to an example embodiment. Specifically, FIG. 10 shows a diagrammatic representation of the machine 1000 in the example form of a computer system, within which instructions 1010 (e.g., software, a program, an application, an applet, an app, or other executable code) for causing the machine 1000 to perform any one or more of the methodologies discussed herein may be executed. For example, the instructions 1010 may cause the machine 1000 to execute the flow diagrams of FIGS. 3-7. Additionally, or alternatively, the instructions 1010 may implement the programs of social networking server 112, the user interface 814, and so forth. The instructions 1010 transform the general, non-programmed machine 1000 into a particular machine 1000 programmed to carry out the described and illustrated functions in the manner described.

In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1010, sequentially or otherwise, that specify actions to be taken by the machine 1000. Further, while only a single machine 1000 is illustrated, the term “machine” shall also be taken to include a collection of machines 1000 that individually or jointly execute the instructions 1010 to perform any one or more of the methodologies discussed herein.

The machine 1000 may include processors 1004, memory/storage 1006, and I/O components 1018, which may be configured to communicate with each other such as via a bus 1002. In an example embodiment, the processors 1004 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1008 and a processor 1012 that may execute the instructions 1010. The term “processor” is intended to include multi-core processors that may comprise two or more independent processors (sometimes referred to as “cores”) that may execute instructions contemporaneously. Although FIG. 10 shows multiple processors 1004, the machine 1000 may include a single processor with a single core, a single processor with multiple cores (e.g., a multi-core processor), multiple processors with a single core, multiple processors with multiples cores, or any combination thereof.

The memory/storage 1006 may include a memory 1014, such as a main memory or other memory storage, and a storage unit 1016, both accessible to the processors 1004 such as via the bus 1002. The storage unit 1016 and memory 1014 store the instructions 1010 embodying any one or more of the methodologies or functions described herein. The instructions 1010 may also reside, completely or partially, within the memory 1014, within the storage unit 1016, within at least one of the processors 1004 (e.g., within the processor's cache memory), or any suitable combination thereof, during execution thereof by the machine 1000. Accordingly, the memory 1014, the storage unit 1016, and the memory of the processors 1004 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1010. The term “machine-readable medium” shall also be taken to include any medium, or combination of multiple media, that is capable of storing instructions (e.g., instructions 1010) for execution by a machine (e.g., machine 1000), such that the instructions, when executed by one or more processors of the machine (e.g., processors 1004), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1018 may include a wide variety of components to receive input, provide output, produce output, transmit information, exchange information, capture measurements, and so on. The specific I/O components 1018 that are included in a particular machine will depend on the type of machine. For example, portable machines such as mobile phones will likely include a touch input device or other such input mechanisms, while a headless server machine will likely not include such a touch input device. It will be appreciated that the I/O components 1018 may include many other components that are not shown in FIG. 10. The I/O components 1018 are grouped according to functionality merely for simplifying the following discussion, and the grouping is in no way limiting. In various example embodiments, the I/O components 1018 may include output components 1026 and input components 1028. The output components 1026 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1028 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1018 may include biometric components 1030, motion components 1034, environmental components 1036, or position components 1038 among a wide array of other components. For example, the biometric components 1030 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1034 may include acceleration sensor components (e.g., accelerometer), gravitation sensor components, rotation sensor components (e.g., gyroscope), and so forth. The environmental components 1036 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1038 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1018 may include communication components 1040 operable to couple the machine 1000 to a network 1032 or devices 1020 via a coupling 1024 and a coupling 1022, respectively. For example, the communication components 1040 may include a network interface component or other suitable device to interface with the network 1032. In further examples, the communication components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1020 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geolocation, location via Wi-Fi® signal triangulation, location via detecting an NFC beacon signal that may indicate a particular location, and so forth.

In various example embodiments, one or more portions of the network 1032 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fit network, another type of network, or a combination of two or more such networks. For example, the network 1032 or a portion of the network 1032 may include a wireless or cellular network and the coupling 1024 may be a Code Division Multiple Access (CDMA) connection, a Global System for Mobile communications (GSM) connection, or another type of cellular or wireless coupling. In this example, the coupling 1024 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA). Worldwide Interoperability for Microwave Access (WiMAX), Long Term Evolution (LTE) standard, others defined by various standard-setting organizations, other long range protocols, or other data transfer technology.

The instructions 1010 may be transmitted or received over the network 1032 using a transmission medium via a network interface device (e.g., a network interface component included in the communication components 1040) and utilizing any one of a number of well-known transfer protocols (e.g., hypertext transfer protocol (HTTP)). Similarly, the instructions 1010 may be transmitted or received using a transmission medium via the coupling 1022 (e.g., a peer-to-peer coupling) to the devices 1020. The term “transmission medium” shall be taken to include any intangible medium that is capable of storing, encoding, or carrying the instructions 1010 for execution by the machine 1000, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
extracting, by one or more processors, values for a plurality of features associated with a user of a social network, the plurality of features being related to a language, the plurality of features comprising profile features, each feature of the plurality of features being a primary feature or a secondary feature;
for each primary feature, determining, by the one or more processors, if a value of the feature exceeds a respective predetermined feature threshold;
determining, by the one or more processors, that the user speaks the language when at least one primary feature exceeds the respective predetermined feature threshold;
when none of the primary features exceeds the respective predetermined feature threshold, analyzing, by the one or more processors, values of the primary features and the secondary features to determine if the user speaks the language; and
storing, by the one or more processors, the determination that the user speaks the language in a profile of the user, wherein a user interface of the social network is customized based on the language.

2. The method as recited in claim 1, wherein the plurality of features further comprises user-connection features and user-activity features, the user-connection features including data about connections of the user, the user-activity features providing data about activities of the user on the social network.

3. The method as recited in claim 1, wherein primary features are features that may determine proficiency in a particular language if a condition associated with the feature is met, the primary features including language spoken at a job location, language spoken at a university attended by the user, language associated with an email domain, and percentage of connections speaking the language.

4. The method as recited in claim 1, wherein secondary features are features that may not by themselves determine if a language is spoken but may contribute to determine if the user speaks the language when combined with other primary or secondary features, the secondary features including social network groups of the user, language certifications of the user, and publications of the user.

5. The method as recited in claim 1, wherein the profile features include one or more of language in the profile, language in an interface locale, language spoken where the user lives or lived, language identified in skills, language spoken at universities attended by the user, language spoken at a job location of the user, language corresponding to groups of the user, language in a sign-up country of the user, language identified in certifications obtained by the user, language of publications of the user, and language associated with an email domain of an email of the user.

6. The method as recited in claim 1, wherein analyzing values of the primary features and the secondary features further comprises:
calculating a weighted sum of values of the primary features and the secondary features indicating the language is spoken.

7. The method as recited in claim 1, wherein analyzing values of the primary features and the secondary features further comprises:
utilizing a machine-learning program to determine if the user speaks the language, the machine-learning program being associated with the plurality of features and being trained with data indicating values of a set of features and an indication if the user speaks the language.

8. The method as recited in claim 1, wherein a plurality of use cases associated with the social network are related to the language determined for the user, the use cases comprising any combination of feed filtering, recruiting, identifying jobs for the user, targeting advertisements, providing education courses, suggesting channels on the social network, identifying possible new contacts for the user, and improving searches.

9. The method as recited in claim 1, wherein the plurality of features includes a number of connections of the user in a country who speak the language, wherein it is determined that the user speaks the language when the number of connections of the user in the country exceeds the respective predetermined feature threshold.

10. The method as recited in claim 1, wherein the plurality of features includes a university attended by the user in a country speaking the language, wherein it is determined that the user speaks the language when the user attended the university for a period exceeding the respective predetermined feature threshold.

11. A system comprising:
a memory comprising instructions; and
one or more computer processors, wherein the instructions, when executed by the one or more computer processors, cause the one or more computer processors to perform operations comprising:
extracting values for a plurality of features associated with a user of a social network, the plurality of features being related to a language, the plurality of features comprising profile features, each feature of the plurality of features being a primary feature or a secondary feature;
for each primary feature, determining if a value of the feature exceeds a respective predetermined feature threshold;
determining that the user speaks the language when at least one primary feature exceeds the respective predetermined feature threshold;
when none of the primary features exceeds the respective predetermined feature threshold, analyzing values of the primary features and the secondary features to determine if the user speaks the language; and
storing the determination that the user speaks the language in a profile of the user, wherein a user interface of the social network is customized based on the language.

12. The system as recited in claim 11, wherein the plurality of features further comprises user-connection features and user-activity features, the user-connection features including data about connections of the user, the user-activity features providing data about activities of the user on the social network.

13. The system as recited in claim 11, wherein primary features are features that may determine proficiency in a particular language if a condition associated with the feature is met, the primary features including language spoken at a job location, language spoken at a university attended by the user, language associated with an email domain, and percentage of connections speaking the language.

14. The system as recited in claim 11, wherein secondary features are features that may not by themselves determine if a language is spoken but may contribute to determine if the user speaks the language when combined with other primary or secondary features, the secondary features including social network groups of the user, language certifications of the user, and publications of the user.

15. The system as recited in claim 11, wherein the profile features include one or more of language in the profile, language in an interface locale, language spoken where the user lives or lived, language identified in skills, language spoken at universities attended by the user, language spoken at a job location of the user, language corresponding to groups of the user, language in a sign-up country of the user, language identified in certifications obtained by the user, language of publications of the user, and language associated with an email domain of an email of the user.

16. A non-transitory machine-readable storage medium including instructions that, when executed by a machine, cause the machine to perform operations comprising:
extracting values for a plurality of features associated with a user of a social network, the plurality of features being related to a language, the plurality of features comprising profile features, each feature of the plurality of features being a primary feature or a secondary feature;
for each primary feature, determining if a value of the feature exceeds a respective predetermined feature threshold;
determining that the user speaks the language when at least one primary feature exceeds the respective predetermined feature threshold;
when none of the primary features exceeds the respective predetermined feature threshold, analyzing values of the primary features and the secondary features to determine if the user speaks the language; and
storing the determination that the user speaks the language in a profile of the user, wherein a user interface of the social network is customized based on the language.

17. The machine-readable storage medium as recited in claim 16, wherein the plurality of features further comprises user-connection features and user-activity features, the user-connection features including data about connections of the user, the user-activity features providing data about activities of the user on the social network.

18. The machine-readable storage medium as recited in claim 16, wherein primary features are features that may determine proficiency in a particular language if a condition associated with the feature is met, the primary features including language spoken at a job location, language spoken at a university attended by the user, language associated with an email domain, and percentage of connections speaking the language.

19. The machine-readable storage medium as recited in claim 16, wherein secondary features are features that may not by themselves determine if a language is spoken but may contribute to determine if the user speaks the language when combined with other primary or secondary features, the secondary features including social network groups of the user, language certifications of the user, and publications of the user.

20. The machine-readable storage medium as recited in claim 16, wherein the profile features include one or more of language in the profile, language in an interface locale, language spoken where the user lives or lived, language identified in skills, language spoken at universities attended by the user, language spoken at a job location of the user, language corresponding to groups of the user, language in a sign-up country of the user, language identified in certifications obtained by the user, language of publications of the user, and language associated with an email domain of an email of the user.
